(19) United States
(12) Patent Application Publication
(10) Pub. No.: US 2025/0211009 A1
(43) Pub. Date: Jun. 26, 2025

(54) IDENTIFICATION OF CHARGER PLUG

(71) Applicant: Intel Corporation, Santa Clara, CA (US)

(72) Inventors: Varshini Ajjampur Vijayakumar, Bangalore (IN); Smit Kapila, Bangalore (IN); Samantha Rao, Bangalore (IN); Nagalakshmi Shashidhara Guptha, Bangalore (IN)

(21) Appl. No.: 18/395,205

(22) Filed: Dec. 22, 2023

(51) Int. Cl. H02J 7/00; H01R 13/717

(52) U.S. Cl. CPC H02J 7/0047; H01R 13/7175

(57) ABSTRACT

Embodiments herein relate to a power cable assembly that includes a light source, an output to provide direct current (DC) power to an electronic device, an input to receive alternating current (AC) power from a power source, first circuitry, and second circuitry. The first circuitry may be configured to identify, from the electronic device, a first signal; generate, based on the first signal, a high-frequency (HF) signal with a frequency at or above 9 kHz; and output, to second circuitry, the HF signal. The second circuitry may be configured to provide power to the light source based on the AC high-frequency signal. Other embodiments may be described and/or claimed.

### BACKGROUND

In situations such as an office, audio/video (A/V) setup, or other situation, there may be a plurality of similar-looking charger plugs that are plugged into a power strip or a multi-port wall outlet. When a user wants to disconnect a charger plug that corresponds to a specific electronic device of a plurality of electronic devices, it may be difficult to identify the desired charger plug from the plurality of charger plugs.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a system that includes a plurality of similar-looking plugs, in accordance with various embodiments.

FIG. 2 illustrates an example of a system that may facilitate charger plug identification, in accordance with various embodiments.

FIG. 3 illustrates an alternative example of a system that may facilitate charger plug identification, in accordance with various embodiments.

FIG. 4 illustrates an example electronic device that may be configured to facilitate charger plug identification, in accordance with some embodiments.

### DETAILED DESCRIPTION

As previously described, if a user wishes to disconnect a charger plug that is charging a specific electronic device of a plurality of electronic devices, it may be difficult to identify which charger plug corresponds to which electronic device. Embodiments herein relate to a configuration wherein the electronic device is to transmit a signal along the power cord to the charger plug, wherein the signal activates a light source (e.g., a light emitting diode (LED) or some other light source) on the charger plug. In this way, the user may be able to identify which charger plug of a plurality of similar-looking charger plugs corresponds to a specific electronic device. In some embodiments, the signal may be transmitted based on a received user input; e.g., a long press of a specific key, a voice command, etc. In other embodiments, the signal may be transmitted based on an identification of a system state of the electronic device (e.g., the battery of the electronic device is full and so the electronic device can be disconnected from power). In other embodiments, the signal may be transmitted based on some other additional or alternative criteria.

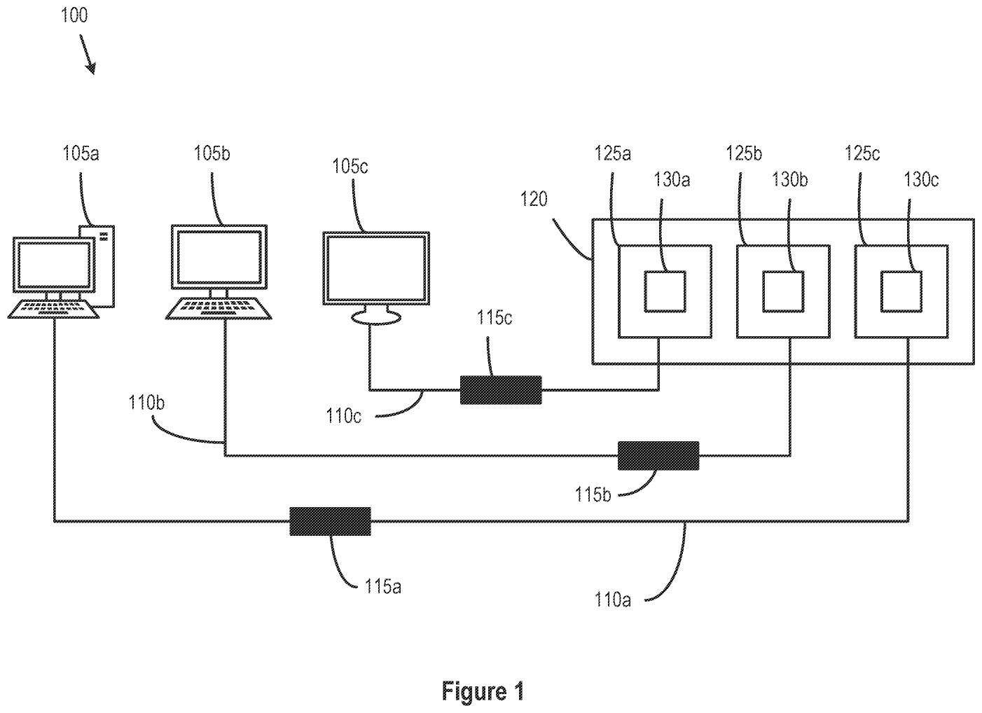

FIG. 1 depicts an example of a system 100 where there may be a plurality of electronic devices such as electronic devices 105a, 105b, and 105c (collectively, “electronic devices 105”). The electronic devices 105 may be, for example, a laptop computer, a desktop computer, a gaming system, a peripheral such as a monitor or printer, and/or some other type of electronic device. Although three different electronic devices, each with a different power cable, adaptor, and charger as described below, are depicted, it will be understood that this depiction is for the sake of discussion only and is not intended to limit embodiments to any particular number or type of electronic device or other elements.

The system 100 may further include a power source 120 that has a plurality of power connections. The power source 120 may be, for example, a power strip plugged into a wall outlet (e.g., a 120 volt (V) wall outlet, a 220 V wall outlet, etc.). In this embodiment, the power strip may include a plurality of power connections such as power outlets that are configured to couple with a plurality of charger plugs. In other embodiments, the power source 120 may be a wall outlet configured to couple with a plurality of charger plugs. In other embodiments, the power source 120 may be some other type of power source or some other configuration that is configured to couple with a plurality of charger plugs as shown in FIG. 1.

Respective ones of the electronic devices 105 may be coupled with the power source 120 by power cables 110a, 110b, and 110c (collectively, “power cables 110”). Specifically, the power cables 110 may include charger plugs 125a, 125b, and 125c (collectively, “charger plugs 125”). Respective ones of charger plugs 125 may be configured to mate with the power source 120 such that alternating current (AC) power may be transferred from the power source 120 to the power cables 110. The power cables 110 may also include an adaptor such as adaptors 115a, 115b, and 115c (collectively, “adaptors 115”). The adaptors 115 may be configured to convert the AC power received from the power source 120 to direct current (DC) power for provision to the electronic devices 105. In some embodiments, one or more of the power cables 110 may be fixedly attached to a respective electronic device (e.g., the power cable 110 is not designed to be un-attached and re-attached by a user). Additionally or alternatively, one or more of the power cables 110 may be configured to be detachable from an electronic device 105 such that a user may “unplug” and re-plug the power cable from the electronic device 105.

In embodiments herein, the respective charger plugs 125 may include a light source 130a, 130b, and 130c (collectively, “light source 130”). In embodiments, the light sources 130 may be a light-emitting diode (LED) and/or some other type of light source. In operation, an input signal may be provided to a charger plug (e.g., charger plug 125a) as described in further detail below, and the input signal may cause the light source 130a to illuminate. In this way, a user may be able to easily identify which of the charger plugs 125 corresponds to which of the electronic devices 105.

It will be understood that embodiments are described herein with respect to a light source located at the charger plug. However, other embodiments may use some additional/alternative form of charger plug identification. For example, in some embodiments the charger plug may include a speaker or vibrating element that is activated in the same way as the light source described herein, thereby producing a noise that can be used to identify the charger plug. In other embodiments, the charger plug may include a mechanical element such as a button or lever that extends or retracts based on the signal provided by the electronic device. In this way, a user may be able to identify the charger plug based on activation of the mechanical element. Other embodiments may have other variations. For the sake of discussion herein, specific embodiments will be described with respect to a light source, but it will be understood that such discussion may be extendable to other identifying elements as discussed above or as may be identified in the art.

Generally, the charger plug identification may be based on use of an analog signal or a digital signal. Identification via analog signal may include generation of a high-frequency (HF) signal by an electronic device (e.g., one of electronic devices 105), and provision of the HF signal to an adaptor (e.g., one of adaptors 115). The adaptor may then provide an HF signal to a charger plug (e.g., one of charger plugs 125), which may in turn activate the optical source (e.g., one of optical sources 130). As used herein, an HF signal may refer to a signal with a frequency between approximately 9 kilohertz (kHz) and approximately 95 kHz, although in other embodiments the frequency of the signal may be higher or lower based on the specific materials used. Additionally, it will be understood that the HF signal is an AC signal in some embodiments. For the sake of discussion, different lines such as an HF DC signal line 265 and an HF AC signal line 255 are discussed. Such labeling is for the sake of discussion regarding whether the line is on the AC side of the power signal pathway (e.g., between a charger plug 125 and an adaptor 115), or on the DC side of the power signal pathway (e.g., between an adaptor 115 and an electronic device 105).

More generally, a control logic (e.g., an embedded controller (EC) and/or some other type of system-on-chip (SoC), a processor, a processor core, etc.) may be used to identify/communicate a user input (e.g., a long key input, a voice command, etc.) or system status (e.g., a fully-charged battery) as a signal that is provided to a power line communication (PLC) injection circuit. The PLC injection circuit introduces an HF signal that is transmitted over the DC power line where it is received by the adaptor. Inside the adaptor, the HF signal may be demodulated from the DC power line and then re-injected as an HF signal on the AC power line where it is transmitted to the charger plug. This HF signal may be demodulated at the charger plug, and cause activation of the light source. In some embodiments, the optical source may be activated for as long as the user or system input is provided, while in other embodiments some form of timer may be used to either limit or extend the amount of time that the light source is activated.

Identification via digital signal may relate to provision of the digital signal from the electronic device (e.g., one of electronic devices 105) to an adaptor (e.g., one of adaptors 115). The digital signal may be in accordance with an interconnect protocol such as universal serial bus (USB) Type C, compute express link (CXL), peripheral component interconnect express (PCIe), and/or some other type of protocol. Upon receipt of the digital signal, the adaptor may then generate and provide an HF signal to the charger plug as described above.

More generally, in this embodiment the EC and/or some other SoC of the electronic device may identify a user and/or system input as described above and provide a signal to a power delivery (PD) controller of the electronic device. The signal may be provided to the PD controller via some form of inter-integrated circuit (I2C) protocol or some other type of protocol. Based on receipt of the signal, the PD controller may generate and transmit a digital signal to a PD controller of the adaptor. For example, the digital signal may be transmitted in accordance with some type of interconnect protocol as described above. In one specific example, if USB Type-C is used, then the digital signal may be transmitted via a configuration channel (CC) line. Based on receipt of the digital signal, the PD controller of the adaptor may cause the generation of the HF signal as described above, which is then provided to the charger plug as described above.

Embodiments herein provide a plurality of advantages. Specifically, embodiments may allow for the identification of the charger plug without requiring a change to the height of one or more of the electronic devices, adaptors, or charger plugs (or components thereof, such as specific circuit boards). Additionally, embodiments may not require a change in power cable standards, while still providing user experience enhancements with relatively low added cost.

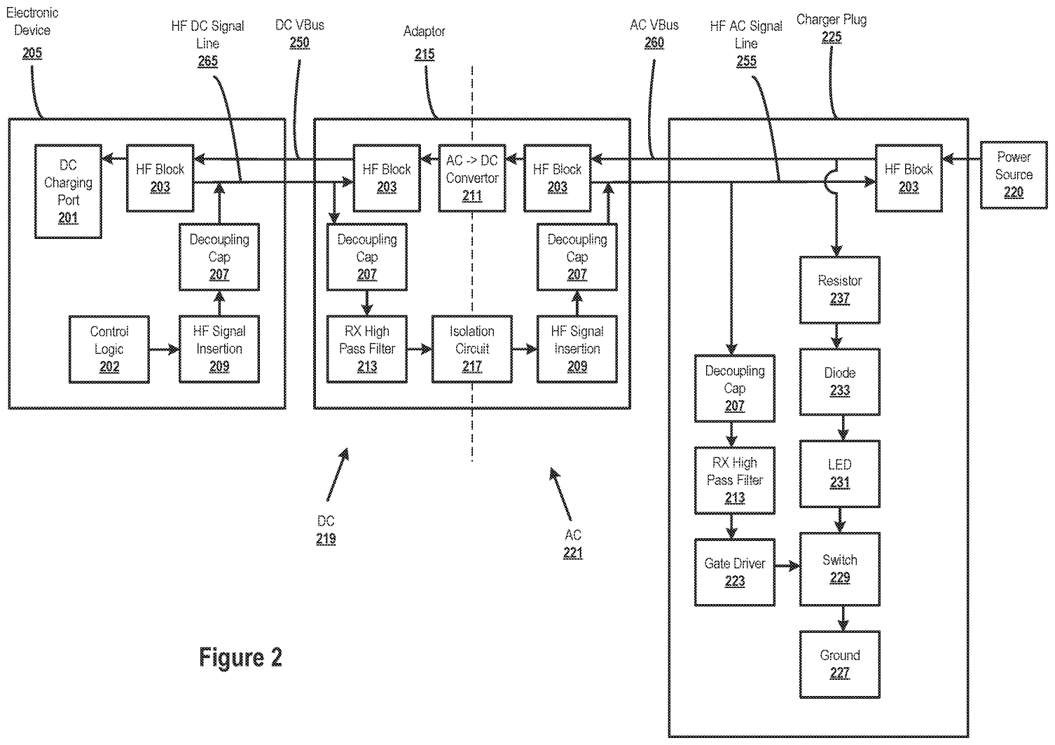

FIG. 2 illustrates an example of a system that may facilitate charger plug identification, in accordance with various embodiments. Specifically, FIG. 2 depicts an example of a configuration that may provide for identification via an analog signal, as discussed above.

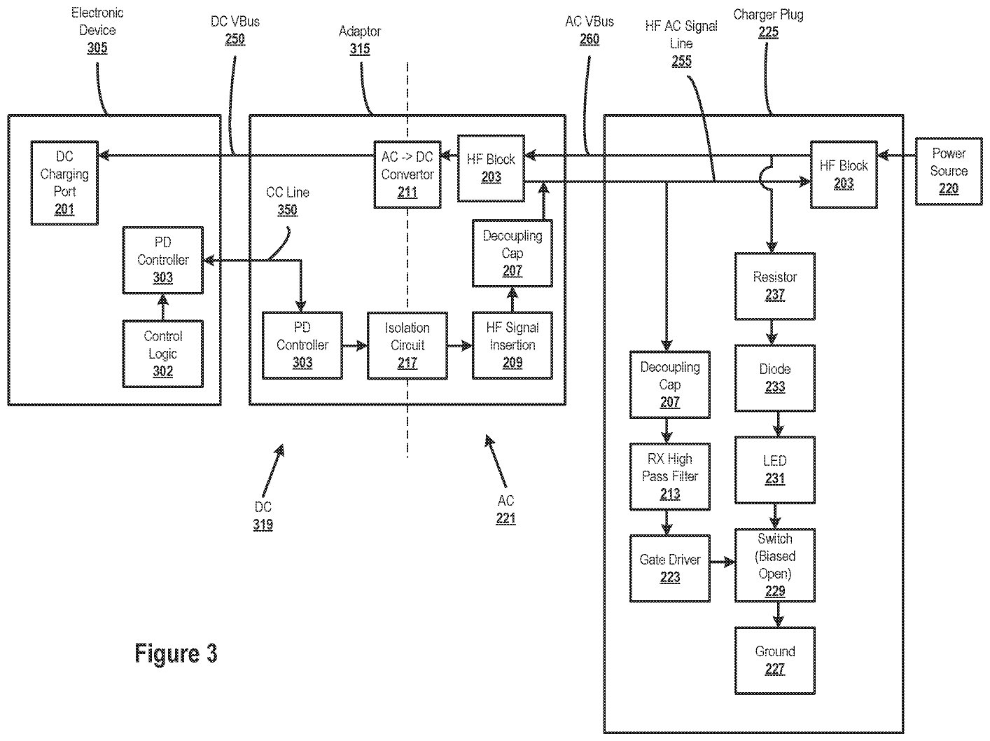

Generally, some or all of the elements of the system of FIG. 2 (and FIG. 3, discussed below) may be considered to be a power cable assembly, be part of a power cable assembly, or include a power cable assembly. The specific delimitation of what elements of FIG. 2 (or FIG. 3) may constitute part of the power cable (e.g., whether parts depicted as being inside of the electronic device 205 are considered parts of the electronic device or parts of the power cable) may vary based on the perception of the user or the specific implementation of embodiments herein. In some embodiments, the adaptor 215 and the charger plug 225 may be considered to be part of a power cable, while in other embodiments the adaptor 215 and/or charger plug may be considered to be different from the power cable. In some embodiments, the adaptor 215 and the charger plug 225, and/or the adaptor 215 and the electronic device 205, may be implemented in a single device or form factor, while in other embodiments the charger plug 225, adaptor 215, and electronic device 205 may be physically separated from one another but communicate by a cable that allows for conveyance of electronic signals between the various devices. To put it more generally, the specific depiction of the number, location, or separation of the various elements is intended as one specific example of one particular implementation, and is not intended to limit embodiments to the single physical depiction of FIG. 2 or 3. As such, the phrase “power cable assembly” will be used herein for the sake of discussion, and may refer in a non-limiting way to a combination of one or more of an electronic device 205/305, an adaptor 215/315, and a charger plug 225, as well as elements of the power cable(s) between the above-listed elements such as the HF DC signal line 265, the HF AC signal line 255, the DC VBus 250, the AC VBus 260, and the CC line 350.

It will also be understood that various elements of FIGS. 2 and 3 are described as circuitry; however, it will be understood that various of the elements (e.g., the various filters, convertors, etc.) may be implemented as hardware, software, firmware, and/or some combination thereof.

Finally, it will be understood that the various communication flows depicted in FIGS. 2 and 3 are intended as highly simplified communication flows. Various additional/alternative circuitry may not be depicted, or there may be additional signal flows between various of the elements that are in a direction opposite to the depicted arrows. These variations are not shown in FIGS. 2 and 3 for the sake of reduction of clutter and redundancy. To put it more simply, the depiction in FIG. 2 is intended for the sake of discussing the flows of various electronic signals and is not intended to depict a specific physical implementation of concepts herein.

The system of FIG. 2 may include an electronic device 205, an adaptor 215, and a charger plug 225, which may be respectively similar to one of electronic devices 105, one of adaptors 115, and one of charger plugs 125. The charger plugs 225 may be communicatively coupled with a power source 220, which may be similar to power source 120. Specifically, the power source 220 may be a wall outlet, a power strip plugged into a wall outlet, or some other type of power source that is configured to provide AC power as previously described.

The AC power may flow from the power source 220 through the charger plug 225 to the adaptor 215 along a power line such as an AC VBus. At the adaptor 215, AC to DC (labeled in FIG. 2 as AC->DC) convertor circuitry 211 may change the received AC power into DC power, and then output the DC power via the DC VBus to the electronic device 205. The DC power may be received at the electronic device 205 at a DC charging port 201, where it may then be redirected to other electronic components or circuitry of the electronic device (e.g., a battery, one or more processors, memory, etc., not shown in FIG. 2 for the sake of lack of clutter of the Figure).

As may be seen in FIG. 2, the system may further include HF signal lines such as the HF DC signal line 265 and the HF AC signal line 255. In various implementations, a power cable such as one of power cables 110 may be formed of a plurality of wires (various of which may be electrically isolated from one another), along which different electronic signals can flow between the depicted elements. The DC and AC VBus 250/260 may be implemented on one of these wires, and the HF signal lines 265/255 may be implemented on another of these wires. In other embodiments, the different electronic signals may be implemented on different wires that are physically separated from one another (e.g., there may be two wires between the charger plug 225 and the adaptor 215, and the AC VBus 260 is implemented on one of those wires while the HF AC signal line 255 is implemented on another of those wires). These are two of the possible variations that are described for the sake of discussion, and other variations may be present in other embodiments.

The electronic device 205 may include control logic 202 that is configured to provide an activation signal to HF signal insertion circuitry 209. The control logic 202 may be, for example, implemented as hardware, software, firmware, and/or some combination thereof. In some embodiments, the control logic 202 may be, be part of, or include an EC, a PD controller, and/or some other type of SoC as described above. In some embodiments, the control logic 202 may be a processor, a processor core, or some other type of logic. The HF signal insertion circuitry 209 may be referred to as a PLC injector. The HF signal insertion circuitry 209 may be configured to receive a signal from the control logic 202 and output an HF signal as described above. Specifically, the control logic 202 may identify a trigger such as a user input (a button-press, a user voice command, etc.) and/or a system input (e.g., an identification that a charge state of a battery of the electronic device is full or above a certain threshold) and provide an activation signal to the HF signal insertion circuitry 209.

The HF signal may be output from the HF signal insertion circuitry 209, where it may pass through a decoupling capacitor 207 to the HF DC signal line 265. The decoupling capacitor may serve as high-pass filters, and block extraneous signals at a frequency below the frequency of the HF signals output by the HF signal insertion circuitry 209 (i.e., “noise”). In some embodiments, the decoupling capacitor may have a capacitance on the order of 1 micro Farad (uF). However, it will be understood that the specific value of the capacitor may depend on the specific implementation and factors such as the frequency of the signal output by the HF signal insertion circuitry 209.

The electronic device may additionally have HF block circuitry 203 positioned between the decoupling capacitor 207 and the DC charging port 201. In some embodiments, the HF block circuitry 203 may additionally/alternatively be referred to as a “wave trap.” The HF block circuitry 203 in the electronic device may act as a low-pass filter, and serve to prevent the HF signal output by the decoupling cap 207 from traveling into the DC charging port. In this way, the relatively low-frequency DC power (which may have a frequency on the order of approximately 50-60 hertz (Hz)) may pass through the HF block circuitry 203 and be received by the DC charging port 201 from the DC VBus 250. However, the HF signal may be prevented from reaching the DC charging port 201 from the HF DC signal line 265.

As previously noted, the HF DC signal line 265 may convey the HF signal from the electronic device 205 to the adaptor 215. As previously noted, the adaptor 215 may include AC to DC convertor circuitry 211, which may be configured to convert the AC power received via the AC VBus 260 to DC power which is then output on the DC VBus 250.

Additionally, the adaptor 215 may generally include a DC side 219 and an AC side 221. The specific sides 219/221 may not be physically separated or arranged as shown but may be logical separations that are depicted for the sake of discussion. Specifically, the DC side 219 may include circuitry that is related to conveyance of DC electronic signals, and the AC side 221 may include circuitry that is related to conveyance of AC electronic signals.

As may be seen, the DC side 219 may include HF block circuitry 203, a decoupling capacitor 207, and a receiver (RX) high pass filter 213. The HF block circuitry 203 and decoupling capacitor 207 may be similar to the HF block circuitry 203 and decoupling capacitor 207 of the electronic device 205 as previously described. Specifically, the HF block circuitry 203 on the DC side 219 may serve as low-pass circuitry that prevents the HF signal on the HF DC signal line 265 from reaching the AC to DC convertor circuitry 211. The decoupling capacitor 207 in the DC side 219 of the adaptor 215 may serve as a high-pass filter that removes extraneous noise from the HF signal received on the HF DC signal line 265. Specifically, the decoupling capacitor 207 may remove signals at the frequencies of the DC or AC power signals (e.g., approximately 50-60 Hz). The RX high pass filter 213 may then filter out additional signals that may cause noise below the frequency of the HF signal.

The HF signal may then be provided from the RX high pass filter 213 to an isolation circuit 217. The isolation circuit may be configured to identify the HF signal and provide an indication to HF signal insertion circuitry 209 of the AC side 211 of the adaptor 215. The HF signal insertion circuitry 209 may be similar to HF signal insertion circuitry 209 of the electronic device. The HF signal may be output from the HF signal insertion circuitry 209 to a decoupling capacitor 207 of the AC side 221 of the adaptor 215, which may act similarly to the decoupling capacitor 207 of the electronic device 205. The HF signal may be output from the decoupling capacitor 207 to the HF AC signal line 255. As may be seen, the AC side 221 of the adaptor 215 may further include HF block circuitry 203, which may prevent the HF signal on the HF AC signal line 255 from entering the AC to DC convertor circuitry 211.

The HF signal may then be conveyed via the HF AC signal line 255 from the adaptor 215 to the charger plug 225. As may be seen, the charger plug 225 may include HF block circuitry 203, which may prevent the HF signal from flowing to the AC power source 220 from the HF AC signal line 255.

The charger plug 225 may also include a decoupling capacitor 207 and an RX high pass filter 213, which may operate similarly to the decoupling capacitor 207 and RX high pass filter 213 of the DC side of the adaptor 215, as previously described. The HF signal may then be provided to gate driver circuitry 223. The gate driver circuitry 223, which may include a frequency-to-voltage converter, may be configured to identify the corresponding signal provided by the RX high pass filter 213, and provide an activation signal to switch 229.

As may be seen in FIG. 2, the switch 229 may be an element of a circuit between ground 227 and the AC VBus 260. The circuit may additionally include LED 231, diode 233, and resistor 237. The resistor may limit the current provided to the LED 231 so that the LED 231 does not receive a damaging power surge when the switch 229 is closed (as described below). In some embodiments, the resistor may have a resistance between approximately 47 kilo Ohms (kΩ) and approximately 63 kΩ. The diode may be unidirectional and biased so as to only allow current to flow from the AC VBus 260 to ground 227 when the switch 229 is closed.

The switch 229 may be biased in an open state. However, when the switch 229 receives a signal from the gate driver 223, the switch may close such that current may flow between the AC VBus 260 and the ground 227. When this happens, the LED 231 may illuminate, thereby providing an indication that the charger plug 225 is associated with the electronic device 205.

FIG. 3 illustrates an alternative example of a system that may facilitate charger plug identification, in accordance with various embodiments. It will be noted that the system of FIG. 3 includes several elements that are similar to those of FIG. 2. Description of such elements will not be repeated herein to avoid redundancy.

The system of FIG. 3 may include an electronic device 305 and an adaptor 315, which may be generally similar to electronic device 205 and adaptor 215. In this embodiment, the electronic device 305 may be configured to provide a digital signal to adaptor 315, rather than the HF signal, as described above.

As may be seen, the electronic device 305 may include control logic 302, which may be similar to control logic 202. In this embodiment, the control logic 302 may identify the user and/or system input as described above and provide a control signal to PD controller 303 of the electronic device 305. The PD controller 303 of the electronic device may be coupled with a PD controller 303 of the adaptor 315. As may be seen, the adaptor 315 may include the PD controller 303 at the DC side 319 of the adaptor 315.

In one embodiment, the PD controllers 303 may be communicatively coupled by a digital signal line such as CC line 350 (which, as noted above, may be implemented via a physical connection in the power cable, and/or via some other type of connection). Based on receipt of the control signal from the control logic 302, the PD controller 303 of the electronic device 305 may generate and transmit a digital signal to the PD controller 303 of the adaptor. The digital signal may be in accordance with an interconnect protocol such as USB Type-C, as previously described. In some embodiments, the digital signal transmitted via the CC line 350 may be an “Identify Plug” message as shown in Table 1, below:

TABLE 1

| | | | | Valid Start |
|---|---|---|---|---|
| Bits 4 . . . 0 | Message Type | Sent By | Description | of Packet |
| 10111 | Identify Plug | Sink or DRP | Initiate PLC | SOP only |

It will be understood that the specific name of the message, the specific digital identifier of the message, etc., are intended as examples of such a message that may be provided by the electronic device 305 to the adaptor 315, and other embodiments may use one or more additional or alternative messages, messages with a different digital value, etc.

Based on receipt of the digital message from the electronic device 305, the PD controller 303 may provide an instruction to the isolation circuit 217, which may be similar to the instruction provided by the RX high pass filter 213 in the embodiment of FIG. 2. The isolation circuit may then provide the previously described instruction to the HF signal insertion circuitry 209.

As previously noted, it will be understood that the embodiments of FIGS. 2 and 3 are intended as highly simplified example embodiments. Other embodiments may include circuitry or logic capable of transmitting both the HF signal and the digital signal as described above. In some embodiments, certain of the depicted elements may be split into separate elements or circuitry, or various of the elements or circuitry may be combined. In some embodiments, additional or alternative connections may be present between the elements beyond what is depicted in the Figures. Other variations may be present in other embodiments.

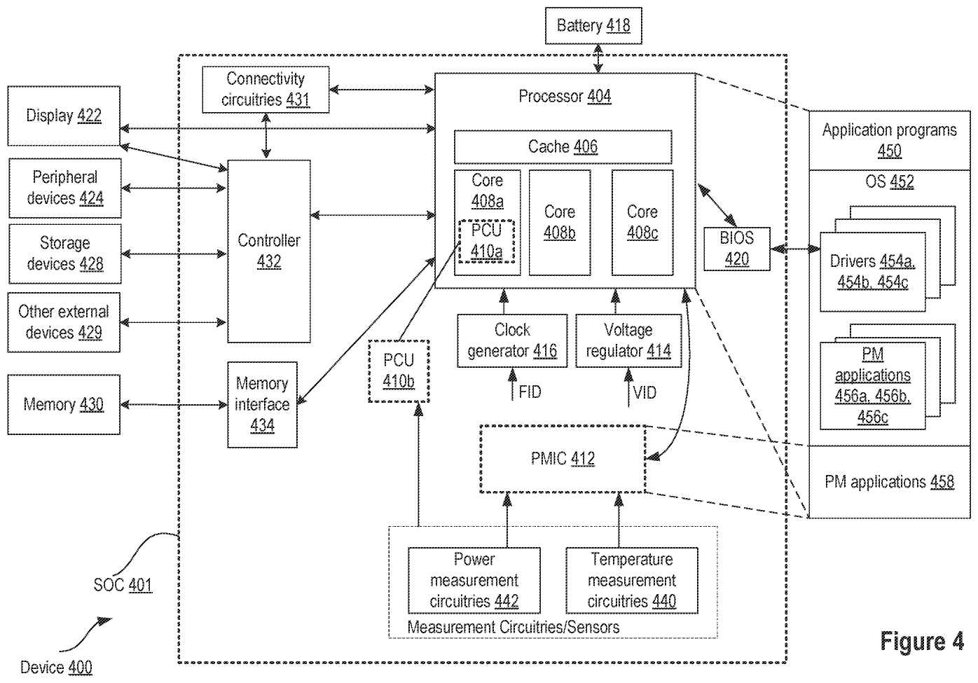

FIG. 4 illustrates an example electronic device that may be configured to facilitate charger plug identification, in accordance with some embodiments.

In some embodiments, device 400 may be similar to one or more of electronic devices 105, 205, and/or 305. In embodiments, device 400 may represent an appropriate computing device, such as a computing tablet, a mobile phone or smart-phone, a laptop, a desktop, an Internet-of-Things (IoT) device, a server, a wearable device, a set-top box, a wireless-enabled e-reader, or the like. It will be understood that certain components are shown generally, and not all components of such a device are shown in device 400.

In an example, the device 400 comprises an SoC (System-on-Chip) 401. An example boundary of the SoC 401 is illustrated using dotted lines in FIG. 4, with some example components being illustrated to be included within SoC 401—however, SoC 401 may include any appropriate components of device 400. It will be understood that the SoC design illustrated in FIG. 4 is intended as only one example design, and other embodiments may include additional or alternative designs, architectures, and/or configurations. For example, in another embodiment, the device 400 may be or include a SiP (System-in-Package) that may be composed of a plurality of chips or chiplets in a single package. Other embodiments may further vary in terms of design, architecture, and/or configuration.

In some embodiments, device 400 includes processor 404. Processor 404 can include one or more physical devices, such as microprocessors, application processors, microcontrollers, programmable logic devices, processing cores, or other processing means. The processing operations performed by processor 404 include the execution of an operating platform or operating system on which applications and/or device functions are executed. The processing operations include operations related to I/O (input/output) with a human user or with other devices, operations related to power management, operations related to connecting computing device 400 to another device, and/or the like. The processing operations may also include operations related to audio I/O and/or display I/O.

In some embodiments, processor 404 includes multiple processing cores (also referred to as cores) 408a, 408b, 408c. Although merely three cores 408a, 408b, 408c are illustrated in FIG. 4, processor 404 may include any other appropriate number of processing cores, e.g., tens, or even hundreds of processing cores. Processor cores 408a, 408b, 408c may be implemented on a single integrated circuit (IC) chip. Moreover, the chip may include one or more shared and/or private caches, buses or interconnections, graphics and/or memory controllers, or other components.

In some embodiments, processor 404 includes cache 406. In an example, sections of cache 406 may be dedicated to individual cores 408 (e.g., a first section of cache 406 dedicated to core 408a, a second section of cache 406 dedicated to core 408b, and so on). In an example, one or more sections of cache 406 may be shared among two or more of cores 408. Cache 406 may be split in different levels, e.g., level 1 (L1) cache, level 2 (L2) cache, level 3 (L3) cache, etc.

In some embodiments, processor core 404 may include a fetch unit to fetch instructions (including instructions with conditional branches) for execution by the core 404. The instructions may be fetched from any storage devices such as the memory 430. Processor core 404 may also include a decode unit to decode the fetched instruction. For example, the decode unit may decode the fetched instruction into a plurality of micro-operations. Processor core 404 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 404 may be an out-of-order processor core in one embodiment. Processor core 404 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 404 may also include a bus unit to enable communication between components of processor core 404 and other components via one or more buses. Processor core 404 may also include one or more registers to store data accessed by various components of the core 404 (such as values related to assigned app priorities and/or sub-system states (modes) association.

In some embodiments, device 400 comprises connectivity circuitries 431. For example, connectivity circuitries 431 includes hardware devices (e.g., wireless and/or wired connectors and communication hardware) and/or software components (e.g., drivers, protocol stacks), e.g., to enable device 400 to communicate with external devices. Device 400 may be separate from the external devices, such as other computing devices, wireless access points or base stations, etc.

In an example, connectivity circuitries 431 may include multiple different types of connectivity. To generalize, the connectivity circuitries 431 may include cellular connectivity circuitries, wireless connectivity circuitries, etc. Cellular connectivity circuitries of connectivity circuitries 431 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, Sixth Generation (6G) wireless system or variations or derivatives, or other cellular service standards. Wireless connectivity circuitries (or wireless interface) of the connectivity circuitries 431 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 431 may include a network interface, such as a wired or wireless interface, e.g., so that a system embodiment may be incorporated into a wireless device, for example, a cell phone or personal digital assistant.

In some embodiments, device 400 comprises controller 432, which represents hardware devices and/or software components related to interaction with one or more I/O devices. For example, processor 404 may communicate with one or more of display 422, one or more peripheral devices 424, storage devices 428, one or more other external devices 429, etc., via controller 432. Controller 432 may be a chipset or some other type of controller.

For example, controller 432 illustrates one or more connection points for additional devices that connect to device 400, e.g., through which a user might interact with the system. For example, devices (e.g., devices 429) that can be attached to device 400 include microphone devices, speaker or stereo systems, audio devices, video systems or other display devices, keyboard or keypad devices, or other I/O devices for use with specific applications such as card readers or other devices.

As mentioned above, controller 432 can interact with audio devices, display 422, etc. For example, input through a microphone or other audio device can provide input or commands for one or more applications or functions of device 400. Additionally, audio output can be provided instead of, or in addition to display output. In another example, if display 422 includes a touch screen, display 422 also acts as an input device, which can be at least partially managed by controller 432. There can also be additional buttons or switches on computing device 400 to provide I/O functions managed by controller 432. In one embodiment, controller 432 manages devices such as accelerometers, cameras, light sensors or other environmental sensors, or other hardware that can be included in device 400. The input can be part of direct user interaction, as well as providing environmental input to the system to influence its operations (such as filtering for noise, adjusting displays for brightness detection, applying a flash for a camera, or other features).

In some embodiments, controller 432 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 422 represents hardware (e.g., display devices) and software (e.g., drivers) components that provide a visual and/or tactile display for a user to interact with device 400. Display 422 may include a display interface, a display screen, and/or hardware device used to provide a display to a user. In some embodiments, display 422 includes a touch screen (or touch pad) device that provides both output and input to a user. In an example, display 422 may communicate directly with the processor 404. Display 422 can be one or more of an internal display device, as in a mobile electronic device or a laptop device or an external display device attached via a display interface (e.g., DisplayPort, High Definition Multimedia Interface (HDMI), etc.). In one embodiment display 422 can be a head mounted display (HMD) such as a stereoscopic display device for use in virtual reality (VR) applications or augmented reality (AR) applications.

In some embodiments, and although not illustrated in the figure, in addition to (or instead of) processor 404, device 400 may include Graphics Processing Unit (GPU) comprising one or more graphics processing cores, which may control one or more aspects of displaying contents on display 422.

Controller 432 may include hardware interfaces and connectors, as well as software components (e.g., drivers, protocol stacks) to make peripheral connections, e.g., to peripheral devices 424.

It will be understood that device 400 could both be a peripheral device to other computing devices, as well as have peripheral devices connected to it. Device 400 may have a “docking” connector to connect to other computing devices for purposes such as managing (e.g., downloading and/or uploading, changing, synchronizing) content on device 400. Additionally, a docking connector can allow device 400 to connect to certain peripherals that allow computing device 400 to control content output, for example, to audiovisual or other systems.

In addition to a proprietary docking connector or other proprietary connection hardware, device 400 can make peripheral connections via common or standards-based connectors. Common types can include a Universal Serial Bus (USB) connector (which can include any of a number of different hardware interfaces), DisplayPort including MiniDisplayPort (MDP), HDMI, Firewire, or other types.

In some embodiments, connectivity circuitries 431 may be coupled to controller 432, e.g., in addition to, or instead of, being coupled directly to the processor 404. In some embodiments, display 422 may be coupled to controller 432, e.g., in addition to, or instead of, being coupled directly to processor 404.

In some embodiments, device 400 comprises memory 430 coupled to processor 404 via memory interface 434. Memory 430 includes memory devices for storing information in device 400.

In some embodiments, memory 430 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 430 can be a dynamic random-access memory (DRAM) device, a static random-access memory (SRAM) device, flash memory device, phase-change memory device, or some other memory device having suitable performance to serve as process memory. In one embodiment, memory 430 can operate as system memory for device 400, to store data and instructions for use when the one or more processors 404 executes an application or process. Memory 430 can store application data, user data, music, photos, documents, or other data, as well as system data (whether long-term or temporary) related to the execution of the applications and functions of device 400.

Elements of various embodiments and examples are also provided as a machine-readable medium (e.g., memory 430) for storing the computer-executable instructions (e.g., instructions to implement any other processes discussed herein). The machine-readable medium (e.g., memory 430) may include, but is not limited to, flash memory, optical disks, CD-ROMs, DVD ROMs, RAMs, EPROMS, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 400 comprises temperature measurement circuitries 440, e.g., for measuring temperature of various components of device 400. In an example, temperature measurement circuitries 440 may be embedded, or coupled or attached to various components, whose temperature are to be measured and monitored. For example, temperature measurement circuitries 440 may measure temperature of (or within) one or more of cores 408a, 408b, 408c, voltage regulator 414, memory 430, a motherboard of SoC 401, and/or any appropriate component of device 400.

In some embodiments, device 400 comprises power measurement circuitries 442, e.g., for measuring power consumed by one or more components of the device 400. In an example, in addition to, or instead of, measuring power, the power measurement circuitries 442 may measure voltage and/or current. In an example, the power measurement circuitries 442 may be embedded, or coupled or attached to various components, whose power, voltage, and/or current consumption are to be measured and monitored. For example, power measurement circuitries 442 may measure power, current and/or voltage supplied by one or more voltage regulators 414, power supplied to SoC 401, power supplied to device 400, power consumed by processor 404 (or any other component) of device 400, etc.

In some embodiments, device 400 comprises one or more voltage regulator circuitries, generally referred to as voltage regulator (VR) 414. VR 414 generates signals at appropriate voltage levels, which may be supplied to operate any appropriate components of the device 400. Merely as an example, VR 414 is illustrated to be supplying signals to processor 404 of device 400. In some embodiments, VR 414 receives one or more Voltage Identification (VID) signals, and generates the voltage signal at an appropriate level, based on the VID signals. Various type of VRs may be utilized for the VR 414. For example, VR 414 may include a “buck” VR, “boost” VR, a combination of buck and boost VRs, low dropout (LDO) regulators, switching DC-DC regulators, constant-on-time controller-based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 410a/b and/or PMIC 412. In some embodiments, each core has a network of distributed LDOs to provide efficient control for power management. The LDOs can be digital, analog, or a combination of digital or analog LDOs. In some embodiments, VR 414 includes current tracking apparatus to measure current through power supply rail(s).

In some embodiments, device 400 comprises one or more clock generator circuitries, generally referred to as clock generator 416. Clock generator 416 generates clock signals at appropriate frequency levels, which may be supplied to any appropriate components of device 400. Merely as an example, clock generator 416 is illustrated to be supplying clock signals to processor 404 of device 400. In some embodiments, clock generator 416 receives one or more Frequency Identification (FID) signals, and generates the clock signals at an appropriate frequency, based on the FID signals.

In some embodiments, device 400 comprises battery 418 supplying power to various components of device 400. Merely as an example, battery 418 is illustrated to be supplying power to processor 404. Although not illustrated in the figures, device 400 may comprise a charging circuitry, e.g., to recharge the battery, based on Alternating Current (AC) power supply received from an AC adapter.

In some embodiments, device 400 comprises Power Control Unit (PCU) 410 (also referred to as Power Management Unit (PMU), Power Controller, etc.). In an example, some sections of PCU 410 may be implemented by one or more processing cores 408, and these sections of PCU 410 are symbolically illustrated using a dotted box and labelled PCU 410a. In an example, some other sections of PCU 410 may be implemented outside the processing cores 408, and these sections of PCU 410 are symbolically illustrated using a dotted box and labelled as PCU 410b. PCU 410 may implement various power management operations for device 400. PCU 410 may include hardware interfaces, hardware circuitries, connectors, registers, etc., as well as software components (e.g., drivers, protocol stacks), to implement various power management operations for device 400.

In some embodiments, device 400 comprises Power Management Integrated Circuit (PMIC) 412, e.g., to implement various power management operations for device 400. In some embodiments, PMIC 412 is a Reconfigurable Power Management ICs (RPMICs) and/or an IMVP (Intel® Mobile Voltage Positioning). In an example, the PMIC is within an IC chip separate from processor 404. The PMIC 412 may implement various power management operations for device 400. PMIC 412 may include hardware interfaces, hardware circuitries, connectors, registers, etc., as well as software components (e.g., drivers, protocol stacks), to implement various power management operations for device 400.

In an example, device 400 comprises one or both PCU 410 or PMIC 412. In an example, any one of PCU 410 or PMIC 412 may be absent in device 400, and hence, these components are illustrated using dotted lines.

Various power management operations of device 400 may be performed by PCU 410, by PMIC 412, or by a combination of PCU 410 and PMIC 412. For example, PCU 410 and/or PMIC 412 may select a power state (e.g., P-state) for various components of device 400. For example, PCU 410 and/or PMIC 412 may select a power state (e.g., in accordance with the ACPI (Advanced Configuration and Power Interface) specification) for various components of device 400. Merely as an example, PCU 410 and/or PMIC 412 may cause various components of the device 400 to transition to a sleep state, to an active state, to an appropriate C state (e.g., CO state, or another appropriate C state, in accordance with the ACPI specification), etc. In an example, PCU 410 and/or PMIC 412 may control a voltage output by VR 414 and/or a frequency of a clock signal output by the clock generator, e.g., by outputting the VID signal and/or the FID signal, respectively. In an example, PCU 410 and/or PMIC 412 may control battery power usage, charging of battery 418, and features related to power saving operation.

The clock generator 416 can comprise a phase locked loop (PLL), frequency locked loop (FLL), or any suitable clock source. In some embodiments, each core of processor 404 has its own clock source. As such, each core can operate at a frequency independent of the frequency of operation of the other core. In some embodiments, PCU 410 and/or PMIC 412 performs adaptive or dynamic frequency scaling or adjustment. For example, clock frequency of a processor core can be increased if the core is not operating at its maximum power consumption threshold or limit. In some embodiments, PCU 410 and/or PMIC 412 determines the operating condition of each core of a processor, and opportunistically adjusts frequency and/or power supply voltage of that core without the core clocking source (e.g., PLL of that core) losing lock when the PCU 410 and/or PMIC 412 determines that the core is operating below a target performance level. For example, if a core is drawing current from a power supply rail less than a total current allocated for that core or processor 404, then PCU 410 and/or PMIC 412 can temporality increase the power draw for that core or processor 404 (e.g., by increasing clock frequency and/or power supply voltage level) so that the core or processor 404 can perform at higher performance level. As such, voltage and/or frequency can be increased temporality for processor 404 without violating product reliability.

In an example, PCU 410 and/or PMIC 412 may perform power management operations, e.g., based at least in part on receiving measurements from power measurement circuitries 442, temperature measurement circuitries 440, charge level of battery 418, and/or any other appropriate information that may be used for power management. To that end, PMIC 412 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 410 and/or PMIC 412 in at least one embodiment to allow PCU 410 and/or PMIC 412 to manage processor core energy at least in part based on value(s) detected by one or more of the sensors.

Also illustrated is an example software stack of device 400 (although not all elements of the software stack are illustrated). Merely as an example, processors 404 may execute application programs 450, Operating System 452, one or more Power Management (PM) specific application programs (e.g., generically referred to as PM applications 458), and/or the like. PM applications 458 may also be executed by the PCU 410 and/or PMIC 412. OS 452 may also include one or more PM applications 456a, 456b, 456c. The OS 452 may also include various drivers 454a, 454b, 454c, etc., some of which may be specific for power management purposes. In some embodiments, device 400 may further comprise a Basic Input/output System (BIOS) 420. BIOS 420 may communicate with OS 452 (e.g., via one or more drivers 454), communicate with processors 404, etc.

For example, one or more of PM applications 458, 456, drivers 454, BIOS 420, etc. may be used to implement power management specific tasks, e.g., to control voltage and/or frequency of various components of device 400, to control wake-up state, sleep state, and/or any other appropriate power state of various components of device 400, control battery power usage, charging of the battery 418, features related to power saving operation, etc.

In some embodiments, battery 418 is a Li-metal battery with a pressure chamber to allow uniform pressure on a battery. The pressure chamber is supported by metal plates (such as pressure equalization plate) used to give uniform pressure to the battery. The pressure chamber may include pressured gas, elastic material, spring plate, etc. The outer skin of the pressure chamber is free to bow, restrained at its edges by (metal) skin, but still exerts a uniform pressure on the plate that is compressing the battery cell. The pressure chamber gives uniform pressure to battery, which is used to enable high-energy density battery with, for example, 20% more battery life.

In some embodiments, pCode executing on PCU 410a/b has a capability to enable extra compute and telemetries resources for the runtime support of the pCode. Here pCode refers to a firmware executed by PCU 410a/b to manage performance of the SoC 401. For example, pCode may set frequencies and appropriate voltages for the processor. Part of the pCode is accessible via OS 452. In various embodiments, mechanisms and methods are provided that dynamically change an Energy Performance Preference (EPP) value based on workloads, user behavior, and/or system conditions. There may be a well-defined interface between OS 452 and the pCode. The interface may allow or facilitate the software configuration of several parameters and/or may provide hints to the pCode. As an example, an EPP parameter may inform a pCode algorithm as to whether performance or battery life is more important.

This support may be done as well by the OS 452 by including machine-learning support as part of OS 452 and either tuning the EPP value that the OS hints to the hardware (e.g., various components of SoC 401) by machine-learning prediction, or by delivering the machine-learning prediction to the pCode in a manner similar to that done by a Dynamic Tuning Technology (DTT) driver. In this model, OS 452 may have visibility to the same set of telemetries as are available to a DTT. As a result of a DTT machine-learning hint setting, pCode may tune its internal algorithms to achieve optimal power and performance results following the machine-learning prediction of activation type. The pCode as example may increase the responsibility for the processor utilization change to enable fast response for user activity or may increase the bias for energy saving either by reducing the responsibility for the processor utilization or by saving more power and increasing the performance lost by tuning the energy saving optimization. This approach may facilitate saving more battery life in case the types of activities enabled lose some performance level over what the system can enable. The pCode may include an algorithm for dynamic EPP that may take the two inputs, one from OS 452 and the other from software such as DTT, and may selectively choose to provide higher performance and/or responsiveness. As part of this method, the pCode may enable in the DTT an option to tune its reaction for the DTT for different types of activity.

Some non-limiting Examples of various embodiments are presented below.

Example 1 may include a power cable assembly comprising: a light source; an output to provide direct current (DC) power to an electronic device; an input to receive alternating current (AC) power from a power source; first circuitry to: identify, from the electronic device, a first signal; generate, based on the first signal, a high-frequency (HF) signal with a frequency at or above 9 kHz; and output, to second circuitry, the HF signal; and the second circuitry to provide power to the light source based on the AC high frequency signal.

Example 2 may include the power cable assembly of example 1, and/or some other example herein, wherein the second circuitry includes: the light source; a switch that is biased to an open state; and a gate driver configured to: identify receipt of the HF signal; and provide, based on the AC high-frequency signal, an activation signal to the switch, wherein the activation signal is to cause the switch to close, and wherein closing of the switch causes power to be provided to the light source.

Example 3 may include the power cable assembly of any of examples 1-2, and/or some other example herein, wherein the first signal is based on a user-provided input to the electronic device.

Example 4 may include the power cable assembly of any of examples 1-3, and/or some other example herein, wherein the first signal is a second HF signal with a frequency at or above 9 kHz.

Example 5 may include the power cable assembly of any of examples 1-4, and/or some other example herein, wherein the first signal is a digital signal in accordance with an interconnect protocol.

Example 6 may include the power cable assembly of example 5, wherein the interconnect protocol is a universal serial bus (USB) Type-C protocol.

Example 7 may include the power cable assembly of any of examples 1-6, and/or some other example herein, wherein the light source is a light-emitting diode (LED).

Example 8 may include the power cable assembly of any of examples 1-7, and/or some other example herein, wherein the first circuitry further includes an AC to DC convertor configured to convert the AC power to the DC power.

Example 9 may include the power cable assembly of any of examples 1-8, and/or some other example herein, wherein the first circuitry is an adaptor of the power cable assembly.

Example 10 may include the power cable assembly of any of examples 1-9, and/or some other example herein, wherein the second circuitry is a charger plug of the power cable assembly.

Example 11 may include an adaptor for a power cable assembly, wherein the adaptor comprises: alternating current (AC) to direct current (DC) circuitry configured to: receive AC power from an AC power source; and convert the AC power to DC power to be output to an electronic device; and second circuitry configured to: receive, from an electronic device, a first signal that includes an indication that a light source of a charger plug of the power cable assembly is to be activated; and output, to the charger plug, an alternating current (AC) signal, wherein the AC signal is to cause the light source to be activated.

Example 12 may include the adaptor of example 11, and/or some other example herein, wherein the first signal is based on a user-provided input to the electronic device.

Example 13 may include the adaptor of any of examples 11-12, and/or some other example herein, wherein the first signal is based on an identification of a system state by a logic of the electronic device.

Example 14 may include the adaptor of any of examples 11-13, and/or some other example herein, wherein the first signal and the AC signal have a frequency at or above 9 kilohertz (kHz).

Example 15 may include the adaptor of any of examples 11-14, and/or some other example herein, wherein the first signal is a digital signal in accordance with an interconnect protocol.

Example 16 may include a charger plug for a power cable assembly of an electronic device, wherein the charger plug comprises: a light source; a switch that is biased to an open state; and a gate driver configured to: receive, from an adaptor of the power cable assembly, an AC signal at a frequency at or above 9 kilohertz (kHz), wherein the AC signal is based on a first signal received from the electronic device, and wherein the first signal is related to an indication that the light source is to be activated; and close the switch based on the AC signal, wherein closing the switch causes activation of the light source.

Example 17 may include the charger plug of example 16, and/or some other example herein, wherein the indication is based on a user input provided to the electronic device by a user of the electronic device.

Example 18 may include the charger plug of any of examples 16-17, and/or some other example herein, wherein the indication is based on a system state identified by a logic of the electronic device.

Example 19 may include the charger plug of any of examples 16-18, and/or some other example herein, wherein the light source is a light-emitting diode (LED).

Example 20 may include the charger plug of any of examples 16-19, and/or some other example herein, wherein the first signal is a digital signal in accordance with an interconnect protocol or an AC signal with a frequency at or above 9 kilohertz (kHz).

Example 21 may include an electronic device comprising: a charging port to receive, from a power source, power via a direct current (DC) VBus of a power cable assembly; and circuitry to output, via a signal line of the power cable assembly, an indication that a light source of a charger plug of the power cable assembly is to be activated.

Example 22 may include the electronic device of example 21, and/or some other example herein, wherein the circuitry includes high frequency (HF) signal insertion circuitry, and wherein the indication is a HF DC signal with a frequency at or above 9 kilohertz (kHz).

Example 23 may include the electronic device of example 21, and/or some other example herein, wherein the signal line is a configuration channel (CC) line, and wherein the indication is a digital signal in accordance with a universal serial bus (USB) protocol.

Example 24 may include the electronic device of any of examples 21-23, and/or some other example herein, wherein the indication is based on an input provided by a user of the electronic device.

Example 25 may include the electronic device of any of examples 21-24, and/or some other example herein, wherein the indication is based on an identification of a system state of the electronic device.

Example 26 may include a power cable assembly comprising: a light source; an output to provide direct current (DC) power to an electronic device; an input to receive alternating current (AC) power from a power source; first circuitry to: identify, from the electronic device, a first signal; generate, based on the first signal, a high-frequency (HF) signal; and output, to second circuitry, the HF signal; and the second circuitry to provide power to the light source based on the AC high-frequency signal.

Example 27 may include the power cable assembly of example 26, and/or some other example herein, wherein the second circuitry includes: the light source; a switch that is biased to an open state; and a gate driver configured to: identify receipt of the HF signal; and provide, based on the AC high-frequency signal, an activation signal to the switch, wherein the activation signal is to cause the switch to close, and wherein closing of the switch causes power to be provided to the light source.

Example 28 may include the power cable assembly of any of examples 26-27, and/or some other example herein, wherein the first signal is based on a user-provided input to the electronic device.

Example 29 may include the power cable assembly of any of examples 26-28, and/or some other example herein, wherein the first signal is a second HF signal with a frequency at or above 9 kilohertz (kHz).

Example 30 may include the power cable assembly of any of examples 26-29, and/or some other example herein, wherein the first signal is a digital signal in accordance with an interconnect protocol.

Example 31 may include the power cable assembly of any of examples 26-30, and/or some other example herein, wherein the interconnect protocol is a universal serial bus (USB) Type-C protocol.

Example 32 may include the power cable assembly of any of examples 26-31, and/or some other example herein, wherein the HF signal has a frequency at or above 9 kilohertz (kHz).

Example 33 may include the power cable assembly of any of examples 26-32, and/or some other example herein, wherein the first circuitry further includes an AC-to-DC convertor configured to convert the AC power to the DC power.

Example 34 may include the power cable assembly of any of examples 26-33, and/or some other example herein, wherein the first circuitry is an adaptor of the power cable assembly.

Example 35 may include the power cable assembly of any of examples 26-34, and/or some other example herein, wherein the second circuitry is a charger plug of the power cable assembly.

In the preceding detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the preceding detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive. While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. A power cable assembly comprising:
a light source;
an output to provide direct current (DC) power to an electronic device;
an input to receive alternating current (AC) power from a power source;
first circuitry to:
identify, from the electronic device, a first signal;
generate, based on the first signal, a high-frequency (HF) signal; and
output, to second circuitry, the HF signal; and
the second circuitry to provide power to the light source based on the AC high-frequency signal.

2. The power cable assembly of claim 1, wherein the second circuitry includes:
the light source;
a switch that is biased to an open state; and
a gate driver configured to:
identify receipt of the HF signal; and
provide, based on the AC high-frequency signal, an activation signal to the switch, wherein the activation signal is to cause the switch to close, and wherein closing of the switch causes power to be provided to the light source.

3. The power cable assembly of claim 1, wherein the first signal is based on a user-provided input to the electronic device.

4. The power cable assembly of claim 1, wherein the first signal is a second HF signal with a frequency at or above 9 kilohertz (kHz).

5. The power cable assembly of claim 1, wherein the first signal is a digital signal in accordance with an interconnect protocol.

6. The power cable assembly of claim 1, wherein the interconnect protocol is a universal serial bus (USB) Type-C protocol.

7. The power cable assembly of claim 1, wherein the HF signal has a frequency at or above 9 kilohertz (kHz).

8. The power cable assembly of claim 1, wherein the first circuitry further includes an AC-to-DC convertor configured to convert the AC power to the DC power.

9. The power cable assembly of claim 1, wherein the first circuitry is an adaptor of the power cable assembly.

10. The power cable assembly of claim 1, wherein the second circuitry is a charger plug of the power cable assembly.

11. An adaptor for a power cable assembly, wherein the adaptor comprises:
alternating current (AC) to direct current (DC) circuitry configured to:
receive AC power from an AC power source; and
convert the AC power to DC power to be output to an electronic device; and
second circuitry configured to:
receive, from an electronic device, a first signal that includes an indication that a light source of a charger plug of the power cable assembly is to be activated; and
output, to the charger plug, an alternating current (AC) signal, wherein the AC signal is to cause the light source to be activated.

12. The adaptor of claim 11, wherein the first signal is based on a user-provided input to the electronic device.

13. The adaptor of claim 11, wherein the first signal is based on an identification of a system state by a logic of the electronic device.

14. The adaptor of claim 11, wherein the first signal and the AC signal have a frequency at or above 9 kilohertz (kHz).

15. The adaptor of claim 11, wherein the first signal is a digital signal in accordance with an interconnect protocol.

16. An electronic device comprising:
a charging port to receive, from a power source, power via a direct current (DC) VBus of a power cable assembly; and
circuitry to output, via a signal line of the power cable assembly, an indication that a light source of a charger plug of the power cable assembly is to be activated.

17. The electronic device of claim 16, wherein the circuitry includes high frequency (HF) signal insertion circuitry, and wherein the indication is a HF DC signal with a frequency at or above 9 kilohertz (kHz).

18. The electronic device of claim 16, wherein the signal line is a configuration channel (CC) line, and wherein the indication is a digital signal in accordance with a universal serial bus (USB) protocol.

19. The electronic device of claim 16, wherein the indication is based on an input provided by a user of the electronic device.

20. The electronic device of claim 16, wherein the indication is based on an identification of a system state of the electronic device.
